(19) United States
(12) Patent Application Publication
(10) Pub. No.: US 2005/0193103 A1
(43) Pub. Date: Sep. 1, 2005

(54) Method and apparatus for automatic configuration and management of a virtual private network

(76) Inventor: John Drabik, Draper, UT (US)

Correspondence Address: JOHN DRABIK, 757 EAST CORNER RIDGE DRIVE, DRAPER, UT, 84020, US

(21) Appl. No.: 10/460,518

(22) Filed: Oct. 8, 2003

Related U.S. Application Data
(60) Provisional application No. 60/389,552, filed on Jun. 18, 2002.

(51) Int. Cl. G06F 15/173; G06F 15/177

(52) U.S. Cl. 709/221; 709/223

(57) ABSTRACT

The present invention provides a method and apparatus for automatic configuration and management of a virtual private network operating over a public data network, and a method and apparatus for delivery of the configuration parameters to client interface equipment participating in the virtual private network. The system defines allowed connections between client and server gateway devices, and the parameters associated with the virtual private network. The system defines methods and apparatus for automatic startup, configuration, and shutdown of nodes of the resulting virtual private network based on factors such as the presence of a configuration carrier device. The present invention also describes a class of pseudo-interface mechanism that can hide the complexity of the underlying system from client devices incorporating the present invention, via a conventional network device interface.

### CROSS-REFERENCE TO RELATED APPLICATIONS

This patent application claims the benefits of a provisional application Ser. No. 60/389,552 filed Jun. 10, 2002, entitled “Method and Apparatus for Automatic Configuration and Management of a Virtual Private Network”, incorporated herein by reference in its entirety.

### BACKGROUND

1. Field of the Invention

The present invention relates to the field of data communications, specifically, techniques and apparatus for configuring and managing secure virtual private networks over public networks or insecure private networks, and methods and apparatus to deliver virtual private network configuration information to one or more client devices or to gateway devices providing services for multiple clients.

2. Related Art

The ever-expanding role of digital data communications within business is well known. Within an organization of more than just a few people, it is not uncommon to see a central Information Technology (IT) department, and a variety of methods, techniques, and apparatus, to provide data communication services over a local area network (LAN) which is operated and maintained by the IT department.

Within an organization there are also a variety of techniques available to control or otherwise limit data access to information that is deemed sensitive or otherwise inappropriate for some users.

The growing trend to worker mobility brings a variety of new issues to the communications scene. In the recent past and even now, many workers use modulator-demodulators (modems) to communicate directly to their central office or a branch office. While there are potential security issues, the point-to-point nature of the phone connection makes security breaches fairly uncommon.

In a similar way, many organizations have in the past relied on the use of leased phone lines or other dedicated equipment to provide communications between major offices, also known as a wide area network (WAN). Such techniques are also common today. As the equipment is dedicated, it is also reasonably secure.

However, both the mobile worker communicating by modem, and the inter-office WAN, face limitations due to communication speed limits and expense. Modems are typically quite slow, limited to speeds of tens of thousands of bits per second, and long distance phone calls can be prohibitively expensive. Wide area networks, leased lines, and expensive and difficult to manage devices, limit their utility for WANs. In many cases, less expensive yet more capable connections are commonly available to both the mobile worker and the IT department, through what are known as Internet Service Providers (ISPs). Workers have come to rely upon ISPs for Internet access via web browsers, email clients, and other services. To make use of higher speed connecting points for the corporate LAN, however, opens the corporate network to security threats from a huge number of sources ranging from a casual interloper to the hard-core criminal.

As a result, a variety of systems have been created to allow the use of public data networks, such as the Internet, to handle inter-site data. A small number of workers, mainly the technically savvy, employ many of the same techniques to allow their own, direct, interaction with the corporate network. The global reach of the Internet, and the common availability of high-speed connecting points in many parts of the world, makes the effort worthwhile. The creation of new methods and devices, typically referred to as Virtual Private Network (VPN) connection equipment or router/gateways, has simplified the access, yet maintained reasonable security for institutions.

However, VPNs are notoriously difficult to setup, maintain, configure, reconfigure, and to disable when appropriate (for example, when an employee leaves the company, or if a security breach is detected). VPNs typically rely upon public data networks, and as a result they are increasingly common targets of attack by outsiders who have access to those public networks. Compounding the threat is the fact that the Internet, and other public data networks use a variety of routes to send data between the endpoint machines in a connection. Thus even though two machines are perhaps only right across the street from each other physically, the communications between them might literally be broadcast around the world, greatly increasing the number of potential points where unfriendly taps on those messages might be attempted.

Methods have also been created to deal with security issues, such as the use of application-space encryption and decryption for specific applications, and a variety of other techniques. Such methods face another serious drawback; for effective use, it is often necessary to replace a number of otherwise standard programs such as web browsers and LAN-ready software, with customized versions that include proprietary security extensions. Such programs are expensive, wasteful, and can be ineffective because it is a difficult problem to create secure encryption techniques, and the low usage of proprietary programs reduces the chance that the costs associated with rigorous development can be recovered. Most VPNs today use lower layer encryption methods, typically at the link layer in the ISO model. As a result, the upper level communications do not have to change, and hardware assistance and other speed-enhancing techniques can be applied to all communications, not just those of a “secure” application.

However, the difficult, time-consuming, and error-prone task of setting up a VPN remains, and encryption methods do not address the configuration of the VPN or the secure delivery of configuration information so that it is not stolen or used inappropriately.

To address such concerns the industry has introduced protocols such as the Simple Network Management Protocol (SNMP). Although SNMP is improving, it also has security issues, and does little to assist in the overall VPN configuration process. In that process, a network administrator must determine the collected interactions between a number of machines that may appear and disappear from the network at various times. Those machines may also require varying access to the overall network and various “points of interest” on the network, such as special software, databases, shared printers, or network-attached devices. As a result, the administrator often must deal with a series of long numeric strings that specify items such as encryption keys, network addresses and an associated netmask on both sides of a VPN connection, and the allowed access, or “visibility” of various resources.

Related requirements include the need to uniquely identify every client of a VPN, and the secure delivery of the various components of configuration information in such a way that each user has secure access to those resources and points of interest that are appropriate for their work.

It is also desirable to provide secure yet transportable VPN settings, enabling mobile workers to use the VPN from a variety of physical locations. Existing VPN management schemes fail to completely address these points.

### SUMMARY

The present invention provides a method and apparatus for delivering virtual private network configuration information to one or more client devices, or to gateway devices providing services for multiple clients, by means of a device that carries the appropriate VPN communication parameters. In one embodiment of the present invention, inserting a cryptographically secure carrier device into an appropriately equipped client or gateway device will establish the virtual private network connection. In another embodiment of the present invention, the carrier device itself is not cryptographically secure, but instead relies on conventional password or other challenge mechanisms before the associated virtual private network connection, as defined by the carrier device, is enabled for the client or local network. In another embodiment of the present invention, the carrier device is not cryptographically secure, and no additional password or other challenge mechanism is used, however, such an embodiment is intended only for low-security VPN situations.

It is another aspect of the present invention to provide methods and apparatus to automatically configure the carrier devices for participation in the virtual private network operating over a public network or an insecure private network. The configuration system may reside at any location, but is typically under the control of a designated individual who may or may not be technically knowledgeable about virtual private networks. In one embodiment of the present invention, the designated individual may instead be a designated third-party entrusted to serve the role of the designated individual; it is possible that such a third party may provide these services in such a way that participants in a given VPN can have their carrier device securely programmed at any suitable location.

It is another aspect of the present invention that it provides a new type of network interface equipment which appears to client computers as a conventional network interface device, but which participates in secure private virtual network when a carrier device is inserted into the network interface equipment. In another embodiment of the present invention, VPN configuration information may be programmed into the network interface equipment or a suitable secure or non-secure carrier device, and enabled when an appropriate security device is detected; such security devices may or may not be physically inserted into the equipment. In one embodiment of the present invention, proximity to a radio-frequency identification (RFID) tag results in activation of the VPN.

One embodiment of the present invention extends the concept of a virtual private network to a new class of network, which we call a Virtual Office. Unlike conventional corporate VPNs, the Virtual Office may have no assumed central location; rather, the participants in the virtual private network may instead themselves define the entire network. In one embodiment of the present invention, even the act of programming the VPN carrier devices may be performed by another entity, relying on well-established certification mechanisms, thus allowing worldwide VPN participation without the need to transport configuration carrier devices to and from a central location.

One embodiment of the present invention provides a method and an apparatus for a pseudo-network interface which appears to client computing hardware as a conventional network device but which includes an encrypted configuration delivery apparatus and an entire secondary computing apparatus which directly uses that configuration information to participate in a virtual private network.

Another embodiment of the present invention provides methods to identify a specific participant in a virtual private network, and remotely disable their participation in the event of a security breach, or if the participant undergoes a change of status that limits their access to one or more machines participating in the virtual private network and possibly to the entire virtual private network. The method allows remote update of the secure carrier device, when it is participating in a secure session, to allow network changes, updates, and reconfigurations, with an associated changeover time, or with time-restricted access to the VPN. Using this mechanism, it is further possible to completely change the characteristics of the VPN, for all participants, at a specified time.

The present invention includes provisions for the concept of a central corporate LAN with remote virtual private network clients potentially including branch offices or other small network, and for a new type of network called the Virtual Office, wherein there is no specific centralized corporate LAN.

One embodiment of the present invention includes a configuration program that accumulates and dispenses address specifications and associated netmasks for individual nodes or groups of nodes involved in the VPN, and for separating addresses into local LAN-specific addresses and also into remote, non-local, address specifications.

One embodiment of the present invention includes methods and apparatus to securely deliver configuration information by means of a dedicated, electronically keyed delivery device including the use of programmable memory.

Another embodiment of the present invention includes methods and apparatus to securely deliver the configuration information by means a small hardware memory device, floppy disk, barcode, or other computer-readable media.

Another embodiment of the present invention includes method and apparatus to securely deliver the configuration information by the use of embedded, programmable logic devices. When so implemented, it is possible to enable or disable the programmable logic device by means of a separate security device, by detecting various forms of secure enabling devices such as radio-frequency ID tags.

Another embodiment of the present invention includes method and apparatus to securely deliver the configuration information by the use of embedded, reconfigurable logic devices. The devices may be reconfigured either by a special programming device, or by means of a separate secure carrier device, or by any other suitable means.

One embodiment of the present invention includes background computer processes (“daemons”) or hardware which simulates the effect of such daemons, for the purpose of determining when a configuration device has been inserted into, attached to, or detected by the system, or removed from the system, and respectively either configure and enable the VPN connection(s), or disable the VPN connection(s) based on a testing decision operation.

One embodiment of the present invention includes VPN configuration commands to create the VPN, modify it, destroy it, to announce the availability of various resources to participants in the VPN in a selective way, and to create, modify, and disable connections to single clients, multiple clients, or the entire VPN.

One embodiment of the present invention includes a configuration control program that detects potential conflicts between participating equipment, such as the improper use of subnetwork definitions and netmasks at two or more VPN client locations. In the event such conflicts are detected, the configuration control program will reconfigure the VPN characteristics of one or more clients, and place the resulting configuration information into a configuration device or send configuration change commands to one or more of the participating devices in the VPN.

Another embodiment of the present invention provides for a default, secure, and uniquely identifiable communications channel between a central VPN control system, and potential client machines, which connection channel can be used to deliver VPN configuration information in the event that use of the configuration hardware apparatus for the delivery of VPN configuration information is not practicable for a given situation.

Another embodiment of the present invention provides a mechanism to disable single members of the VPN, or groups of members of the VPN, from the central control computer through use of a uniquely encrypted message that reduces the chance of a Denial Of Service attack by a third party.

One embodiment of the present invention includes configuration parameters that themselves include the definition of specific groups of addresses between which secure VPN communications are to be allowed, and one variation of that embodiment includes the use of Internet Protocol (IP) addresses.

In another embodiment of the present invention, one or more databases may be updated to reflect changes in the VPN, including the unique identification code, method of delivery for a particular client, individual and group access restrictions and access rights, and information related to the default secure communication channel that might be used between the VPN control computer and a specific VPN client gateway or device, including uniquely identifiable default secure communication channels.

In another embodiment of the present invention, various devices including computers, network gateways, and other devices, use the securely delivered or securely enabled configuration information to facilitate VPN communications between devices coupled to the public data network through an Internet Service Provider or through other connection mechanisms.

### DESCRIPTION OF THE FIGURES

Additional objects and features of the present invention will become more apparent and the invention itself will be best understood from the following Detailed Description of Exemplary Embodiments, when read with reference to the accompanying drawings.

FIG. 1 illustrates a public network or insecure private network including VPN router/gateways or an integrated VPN and configuration pseudo-network interface or a generic VPN network interface.

FIG. 2 is a flowchart illustrating the steps used to detect and program a uniquely identified key device with the operational parameters necessary to establish a VPN connection with a client device.

FIG. 3 is a flowchart illustrating the client configuration process such as determining the type of device used by the client, detecting an inserted or attached device, extracting and decrypting the operational parameters, configuring the VPN and starting or restarting the VPN with those parameters.

FIG. 4 is a list of typical data objects used in one embodiment of the present invention.

FIG. 5 is a list of typical functions associated with definition of data objects and the configuration of devices using those objects, including functions to program, erase, test, assign, unassign, enable, and disable configuration devices.

FIG. 6 shows a Uniform Modeling Language (UML) representation of a typical database containing VPN configuration information.

FIG. 7 shows a generic representation of a computing device acting as the VPN Control Station.

FIG. 8 shows a possible software configuration suitable for use as the VPN Configuration management code.

FIG. 9 is a generic representation of a computing device, which could serve as the VPN client stations.

FIG. 10 shows an example of a programmable key device.

FIG. 11 shows a method for a configuration device that changes the way in which the configuration device is used. In this figure, a mechanism is shown for determining whether or not the key may be removed from the client router/gateway device without resulting in the loss of the VPN tunnel, although other functions of a similar nature can also be defined. The diagram also demonstrates the detection of Points of Interest, and the use of the associated settings to provide resources to the client.

FIG. 12 shows a mechanism for a pseudo-network interface card which contains an embodiment of the present invention, but which appears to a computer or other computing device as a conventional network interface device such as a PCI- or ISA-bus Ethernet card, PCMCIA wireless interface card, or other such device.

### DEFINITIONS

Address—a network address used by one or more participants in a VPN. It is worth noting that a VPN typically “maps” local addresses used by one client device, onto a larger group of potential addresses used by all of the participants in the VPN.

Carrier Device—a device which is used to transport VPN configuration information to a an appropriate hardware device. A carrier device may or may not include security and encryption services to restrict access or otherwise limit the usefulness of the device when inserted into a non-authorized networking device.

Configuration Device—another name for a Carrier Device, but usually implying that it includes security mechanisms in addition to simple data carriage.

Configuration Parameters—parameters which control the configuration of a VPN client or server device, and which are held in an appropriate security device, carrier device, or in the memory of an appropriately enabled device.

Daemon—a background process running on a computing system, typically associated with a monitoring task of some kind, and which can cause other programs or operations to be executed based upon decision steps within the daemon. Within the context of the present invention, descriptions are based upon the use of a daemon process that can detect various events such as hardware insertion and removal, although other mechanisms are possible, including user-directed non-automatic detection but resulting in automatic configuration of the VPN tunnel.

Enterprise Address—an address on the same physical network, usually located at a centralized location for a given business. The enterprise address is often considered the central network of a VPN, although there is no particular requirement for such an interpretation.

Local Address—an address on the same physical network such as a home or client network.

Local Network—an enterprise or client network, or an individual computing machine address, separated from a public data network or insecure private network by a VPN gateway.

Network Address/Network Mask Pair—the combined specification of a specific network identifier, and a mask which simplifies various operations on the associated physical network.

Node—a device which is attached to a local network, or, an individual device which is not attached to a network but which has an assigned network address.

Non-local Address—an address on any external network such as an enterprise network or another client network.

Security Device—a device, typically employing a certifiably unique identification number which cannot be modified. Examples include devices such as appropriately programmed hardware devices, “SmartCards”, “JavaCards”, hard-sector storage devices that have been appropriately configured, and some types of Radio Frequency Identification (RFID) devices.

UML—Uniform Modeling Language, a term which refers to a syntax and semantics that can be used to describe a variety of data formats and operating processes. Within the present document, UML is used to describe a potential database representation which could be used as the basis for an embodiment of the present invention.

VPN—Virtual Private Network, a term which refers to various ways in which a public data network or insecure private data network can have data wrapped in a secure and encrypted form so that it is not easily examined by others who may have access to the public data network, yet allowing transport using the standard services of such a public data network.

### DETAILED DESCRIPTION OF THE INVENTION

The description which follows is intended to enable any person skilled in the art to make and use the invention and is provided in the context of a particular application and the associated requirements. Modifications of various types will be readily apparent to those skilled in the art, and such modifications and embodiments are possible without deviating from the scope and spirit of the present invention. The present invention is not intended to be limited to the embodiments shown and described herein, but is to be accorded the widest interpretation and scope consistent with the principles and features herein disclosed.

The general principles described herein may be applied to other embodiments and applications, or to use alternative techniques, without departing from the scope and spirit of the present invention. Although the present invention is described mainly in terms of using the Internet as a communications backbone, the concepts, methods, techniques, and apparatus are broad enough to accomplish the secure delivery and use of virtual private network configuration information and the resulting virtual private network(s) over other public or insecure communications media.

Within this description various and numerous specific details and particular implementation choices are described and set forth. At the same time, well-known protocols, structures, data descriptions, and various hardware and software system components have not been shown or described in order to avoid cluttering or obscuring the present invention. Specific details that may be included are the particular form of network or other addresses, particular networking protocols, one or more typical encryption, decryption, and digital signature methods, and various other specific items, in order to provide understanding of the present invention. In all such cases, however, it will be expressly understood that the present invention may be rendered without such specific details.

The system defines the parameters in such a way that they include verification that multiple VPN devices will not interfere with each other. The network configuration information is loaded into devices which are inserted into, attached to, or known to client computers or VPN gateways which use the configuration information to automatically establish a virtual private network connection, to use that connection, to change that connection in various ways, and to breakdown the connection when it is no longer needed or when the system administrator deems it necessary to do so for security or other reasons.

One embodiment of the present invention includes apparatus to securely transport the configuration parameters that are defined on a configuration server, to one or more VPN client gateway devices or directly to the computers which will participate in the VPN, using a form of pseudo network interface card. Another embodiment of the present invention includes apparatus that uses reconfigurable logic devices to perform the task of configuring a VPN connection between devices. Another embodiment of the present invention includes apparatus with reprogrammable logic devices to perform the task of configuring a VPN connection between devices.

Another embodiment of the present invention includes apparatus to transport the VPN configuration information over a previously established secure connection between the VPN server and one or more client devices. A variation of that embodiment includes mechanisms that delay or defer use of those parameters until a specific future time, or the occurrence of a specific event.

Another embodiment of the present invention includes apparatus such as a disk, barcode, or other computer-readable media to transport VPN configuration information to a configuration program or engine within VPN clients, client devices, or client gateways.

Another embodiment of the present invention includes mechanisms for delivery of the configuration parameters via insecure means, but enabling the associated VPN only when a security device is detected by the associated client device.

Another embodiment of the present invention includes the ability to package network points-of-interest such as the network address of various devices and services which may be useful to clients participating in the virtual private network and the secure delivery of said network information to one or more client devices resulting in the automatic access to said network points-of-interest by one or more client devices.

The methods and apparatus of the present invention are further extended to define a new class of Virtual Private Network known as the Virtual Office. Unlike traditional VPN configurations which rely upon and interact with a specific and well-known enterprise network, a Virtual Office exists entirely within the cloud of a public data network as specified by the client devices connected to that network, and with no single identifiable central enterprise network.

The present invention is not limited to a particular implementation mechanism or technique, and various approaches will be apparent to those skilled in the arts once the functions and mechanisms of the current invention are described. For example, both hardware and software implementation techniques will be obvious and apparent, as will various combinations of such techniques. In addition, the skilled practitioner may consider many obvious implementation mechanisms related to security devices, including physically attached devices and remotely sensed devices such as RFID devices, optical processors, fingerprint detectors, biometric devices, retinal scanners, and various forms of quantum devices.

### Description of Virtual Private Networks

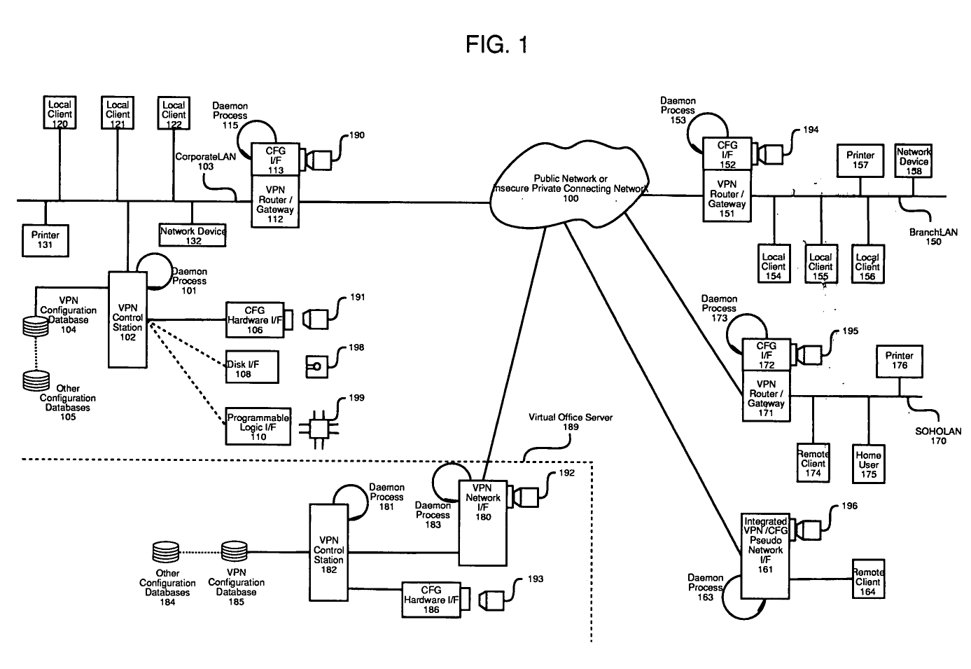

FIG. 1 illustrates a public network or insecure private network 100 including virtual private network (VPN) router/gateways 112, 151, 171 or an integrated VPN and configuration pseudo-network interface 161 or a generic VPN network interface 180 in accordance with an embodiment of the present invention. The router/gateways or network interfaces have their operational characteristics defined by a VPN control station 102 and delivered via one of various configuration transport devices such as 190, 191, 192, 193, 194, 195, 196, 198, and 199 in accordance with an embodiment of the present invention. Public network 100 may be any type of communication media, including but not limited to data networks such as the Internet.

VPN router/gateway 112 couples the corporate local area network (LAN) 103 to public network 100 through router/gateway 112, although it is to be understood that there is no specific requirement for a corporate LAN in the context of the present invention, and the devices herein described as “clients” of the corporate LAN may instead fully comprise the “corporate” network by means of the present invention, when operating as a Virtual Office. Router/gateway 112 is shown using a configuration interface (CFG I/F) 113 and associated control daemon process 115 and a uniquely identifiable security device 190. The skilled practitioner will recognize that this router/gateway represents a special case in the overall VPN structure since it is within the assumed-secure corporate facilities, and thus it is not strictly necessary for router/gateway 112 to use such a configuration mechanism, and could rely instead on existing conventional configuration methods such as simple network management protocol (SNMP). Such usage would not impact the overall operational nature of the VPN as described herein.

An additional and important variation on the corporate LAN made possible by the present invention is shown within the dashed box identified as Virtual Office Server 189, which will be fully described in a subsequent section. For purposes of the following discussion, there are few distinctions between the two types of corporate network-defining models, although it would be atypical to include both a Virtual Office Server and a corporate LAN in any particular VPN configuration.

Corporate LAN 103 is illustrated with three local client workstations 120, 121, and 122, printer 131, and other network-attached devices 132, each coupled in some manner such as a conventional network card, wireless link, or other method, to corporate LAN 103. As noted, corporate LAN 103 is also coupled to VPN router/gateway 112, which provides the connection from the corporate LAN to public network 100. VPN control station 102 is also shown coupled in some manner to corporate LAN 103, although as noted above, a subsequent section concerning Virtual Office Server will describe a new corporate network architecture that does not require such a connection. Furthermore, one embodiment of the present invention would not directly include VPN control station 102. Instead, functions of the control station, such as VPN definition and device programming, would be provided by a trusted third party.

In a similar manner, VPN router/gateway 151 couples branch LAN 150 to public network 100. Branch LAN 150 in turn includes local clients 154, 155, and 156, a local printer 157, and possible other network attached devices 158 such as modems, storage devices, or other items of utility that have a network address that can be carried in the configuration device 194 and used by configuration interface 152 with the assistance of daemon process 153 or some equivalent mechanism. Within the branch LAN, it is assumed that all of the client devices are in some way related to the operations of the business, although this is by no means a necessary condition, and it is possible to limit the access of individual clients. Furthermore, within the context of the present invention, it is neither necessary nor does it affect operations in any way, if items of utility are not listed or described in the configuration device settings.

In a similar manner, VPN router/gateway 171 couples a small office/home office (SOHO) LAN to public network 100. In minor contrast to the preceding paragraph, the SOHO LAN demonstrates that it is not necessary to limit the local network 170, or the equivalent branch LAN 150 or corporate LAN 103, to worker client machines. VPN communications can co-reside with non-VPN or other communications such as between home user machine 175 and the Internet. Such machines would be potentially capable of participating in some VPN transactions depending on various security settings put in place by the VPN Control Station 102 operator, if desirable. For purposes of this discussion, home user machine 175 and others like it are assumed not to participate in VPN communications, but may simultaneously engage in other communications with public network 100 via the same VPN router/gateway hardware. This is a common operation, and no specific claims are made in association with such operation.

It is important to note that the various LAN variations, i.e. Corporate LAN 103, Branch LAN 150, and SOHO LAN 170, do not have to share the same physical characteristics or network protocols. It is only necessary that an addressing mechanism, and any potential address translation, can be handled by the associated router/gateway or related equipment.

The VPN Control Station 102 uses information in the VPN configuration database 104, and potentially from other databases including, but not limited to, employee databases, business databases, or various other databases which might be useful to categorize a particular employee or the equipment he uses, and thus may be of interest to the VPN control station operator. The VPN control station operator uses the information from the configuration database to program CFG configuration devices such as 190, 191, 192, 193, 194, 195, 196, 198, and 199. When such devices are inserted into CFG configuration hardware programming interface devices 105 or 110, or writable media is inserted into a writing device 108, it may be automatically detected using a daemon process 101 or an equivalent detection mechanism, or the VPN control station operator may manually indicate that a device is ready for configuration data.

Upon such a detection or indication, VPN control station 102 contains software and hardware that can read the configuration database and potentially other databases, determine a non-conflicting configuration of network settings for a particular VPN client, including the advertisement of Points Of Interest such as shared printers or other devices that may be available for VPN clients, and the resulting combination of addresses, netmasks, control bits, and other related items are encrypted and written to the CFG configuration device 191 or other similar devices as noted above. Each programmable configuration device is assumed to include a unique identification number key which is included in the encrypted content.

A variety of methods are available for securely determining whether the resulting programmed device has been tampered with, including Digital Signatures and other techniques. The mechanism employed may be bidirectional; in other words, it may be possible to restrict usage of the programmed device to a single client gateway device if desired, through appropriate use of such cryptographic signatures, although such use is not required. Once programmed and verified, the CFG configuration device such as 191 or written media such as 198 can be removed from the programming or writing interface unit, and transported to the location where it will be used, whereupon it is inserted into or attached to a device such as one of the router/gateway configuration interface units 113, 152, 172, or variations on such a device such as an integrated VPN/CFG pseudo-network interface device 161 or VPN Network Interface 180. Once inserted or attached, the device may be detected by a daemon process 115, 153, 163, 173, or 183, or by an equivalent operator action such as pressing a reset button, whereupon the CFG device is read, decrypted, the contents verified, and then used to configure the VPN router/gateway device 151 or equivalent device. Other similar variations on such operations will be obvious to one skilled in the art, including those which use bi-directional cryptographic locking mechanisms which restrict use of a given configuration device to operate only with a specific router/gateway or other client device. The operation of VPN control station 102 is described in detail in a later section.

The VPN control station 102 may use information from additional databases not specifically related to VPN configuration and management. For example, it may be desirable to use information from an employee database to determine which subnetworks may be used by a particular employee, based upon their workgroup membership. As another example, the present invention defines mechanisms for remotely disabling a VPN client connection as it exists in a VPN router/gateway such as router/gateway 161 or 171 and associated configuration CFG devices 195 or 196; in the event that an employee is terminated, the VPN control station operator could use that information to disable the associated VPN configuration devices 195 or 196, and thus disable VPN communications through router/gateways 161 or 171. One embodiment of the present invention includes a monitoring process which can detect when an attempt is made to use a configuration device which has been invalidated, and can send pending messages to disable the remote configuration device, alert a security officer, and log the attempted access. As yet another example, VPN access might be extended to a customer during a development project; upon completion of that project, the VPN connection could be terminated permanently and easily. Another embodiment of the present invention uses cryptographically shrouded information that results in automatic disablement of a configuration device at a specific future time, or in the event of another specific event. Yet another embodiment of the present invention changes the configuration of a remote configuration device based upon similar criteria; using this mechanism, for example, an entire VPN can be reconfigured, new subnetwork and other address assignments delivered (over the already established cryptographically secure connection), and all stations can be ordered to reprogram their carrier devices and restart their VPN connections based upon a specific event such as a time marker, or disappearance of a particular VPN client or host connection.

One embodiment of the present invention includes a defined default VPN configuration which can be restored in the event of an operation such as a special router/gateway system reset. In that embodiment, if the remote user presses and holds the hardware reset button for more than 10 seconds, the default VPN configuration parameters are used, thus providing a default connection to the corporate LAN, but with restricted functionality suitable for troubleshooting or other such purposes.

The placement and specific interconnection of VPN router/gateways as shown in FIG. 1 and the overall system architecture represent just one potential orientation, and other configurations are possible, subject to the condition that the VPN router/gateway must be in the path between a local network or client device, and the public data network or insecure private data network. Data that is transmitted or received by and between the VPN sites typically encounter a great many other networking devices and interfaces, in some cases including multiple network protocol types. For example, within a given LAN or subnetwork, current Internet Protocol (IPv4) data packets may be used, while another subnetwork, or the connection to the insecure public data network, may use the emerging IPv6 protocol.

Such variations have no specific impact on the present invention. However, data networks can often carry data packets that belong to a variety of other protocols, such as various types of multicasting or broadcasting protocols like real time streaming protocol RTSP. Not all devices are capable of correctly handling such protocols, however, and it is possible that those faulty mechanisms could affect VPN communications in general, and the transmission of specific items such as VPN-disabling commands from the VPN control center 102, to one or more VPN client router/gateways such as router/gateway 171. Those skilled in the arts will realize that well-known mechanisms such as tunneling, that is, the encapsulation of one type of protocol within another different protocol, provide mechanisms for avoiding such issues, but such tunneling may impact the operation the overall VPN until they are resolved, and are not described further herein.

The overall functionality of the VPN is that when data packets are sent between machines on different subnetworks (for example, between a remote client and the corporate LAN), the router/gateway at the sending end encrypts and authenticates the data, optionally compressing the data, and encapsulating the resulting encrypted and authenticated data within a packet that appears as a standard networking packet, though with apparently garbled contents. The receiving VPN router/gateway performs the inverse operations, authenticating and decrypting the contents and reformatting the resulting data before routing it to the destination subnetwork or client device. The present invention pertains to the automatic configuration and automatic use of the complex set of values required to cryptographically secure the VPN connections, to extensions associated with defining resources available to various remote clients, and to extensions associated with those situations where no identifiable corporate LAN exists.

### Description of Virtual Office Server

In the past, virtual private networks were routinely treated as an extension of a corporate LAN, in part because it was the only recognizable model, and in part due to the difficulty of configuring and maintaining a VPN, a task usually assigned to a central Information Technology (IT) office. By virtue of the present invention, a new class of VPN network architecture becomes possible, one in which there is no identifiable corporate LAN, and where all participants in the corporate network communications are considered to be VPN clients. Such an architecture is described herein as Virtual Office Server (VOS) 189. This section clarifies the assumptions and the differences between a conventional corporate LAN, and this new form of virtual corporate network architecture.

As noted previously, it would be atypical to include both a conventional corporate LAN and a virtual office server; examples of such a situation would include mirroring operations between the corporate LAN-based VPN Control Station 102 and associated databases 104 and 105, and the virtual office server VPN Control Station 182 and associated databases 184 and 185, for purposes of off-site backup, redundancy in the event of catastrophic failure of the corporate LAN, and similar special events. However, such mechanisms will not be discussed further here.

The role of virtual office server 189 is to provide the configuration and control methods needed to manage a completely virtual office environment, one in which there is no identifiable centralized corporate LAN, and where all workers are presumed to be VPN clients, either stand-alone or small office/home office (SOHO) based, or branch offices housing several such workers.

Operationally, there are distinct differences between VOS and a conventional VPN architecture, such as the lack of a central corporate LAN, and access to the resources typically associated with such a corporate LAN. In addition, the lack of a central LAN implies that there is not necessarily a central routable network address, and instead all of the clients may have dynamic, non-routable, network addresses; as a result, whenever the dynamic settings for a given client change (such as might occur at the whim of their service provider), it may become necessary to inform other clients of that change, and to reconfigure one or more aspects of those remote client connection tables, especially if those clients are identified as potential users of a resource available via the client whose network address has changed. The present invention provides optional mechanisms for transmitting the change information to an appropriately constructed router/gateway, reprogramming the carrier device associated with that router/gateway, restarting the VPN connections, and perhaps identifying a change in status for various resources.

In the situation where a given VPN client has their own local resources such as printer 157 or other such devices 158, which are not shared with other VPN clients, no such notification of resources is necessary, but it may still be necessary to inform the remote machines of the change of VPN connection information so that overall connectivity may be maintained. In the situation where devices such as printer 157 or network-attached device 158 are shared between clients, they become Points Of Interest (POI), which can be shared between VPN clients in the same manner that POI sharing was noted in the section describing a conventional corporate LAN and VPN architecture. In the context of the present invention, and when so equipped, the present invention includes mechanisms to redefine the appropriate POI information for remote clients, when such POI information is affected by a change of settings for any one of the supplying clients.

Conceptually, the only difference is that VPN clients must decide which resources they will share, and make information about those resources available to the VPN Control Station operator so that the information can be encapsulated in programmed devices for delivery to other VPN clients, and can thus enable access to the devices by other VPN clients. However, the present invention also includes mechanisms to advertise the availability of particular resources even under the situation where a central VPN control station does not exist.

In a Virtual Office setting, VPN control station 182 attaches to or includes CFG hardware interface 186 and operates with a control daemon process 181 or direct operator interaction with the VPN control station 182 to detect when a programmable device of an appropriate type is inserted into the CFG Hardware programming interface 186. It is worth noting again that the VPN control station may not physically exist as a device connected to or known to the VPN clients, but may instead be provided by a trusted service. VPN control station 182 uses configuration database 185, possible additional and useful databases 184, to program CFG devices such as 193 and prepare them for use. The skilled practitioner will recognize that a variety of programmable objects can be used in the role of the CFG programming hardware interface 186 and the associated device to be programmed 193, such as machine readable media, written with configuration information, which in turn can then be used by VPN router/gateway access devices such as 151, 171, integrated VPN/CFG pseudo-network interfaces such as 161, or directly programmable VPN network interfaces such as 180. Such combinations of configuration devices and their interfaces or writable media and the associated writers, are referred to generically as Configuration Apparatus (CFG).

### Description of Configuration Apparatus (CFG)

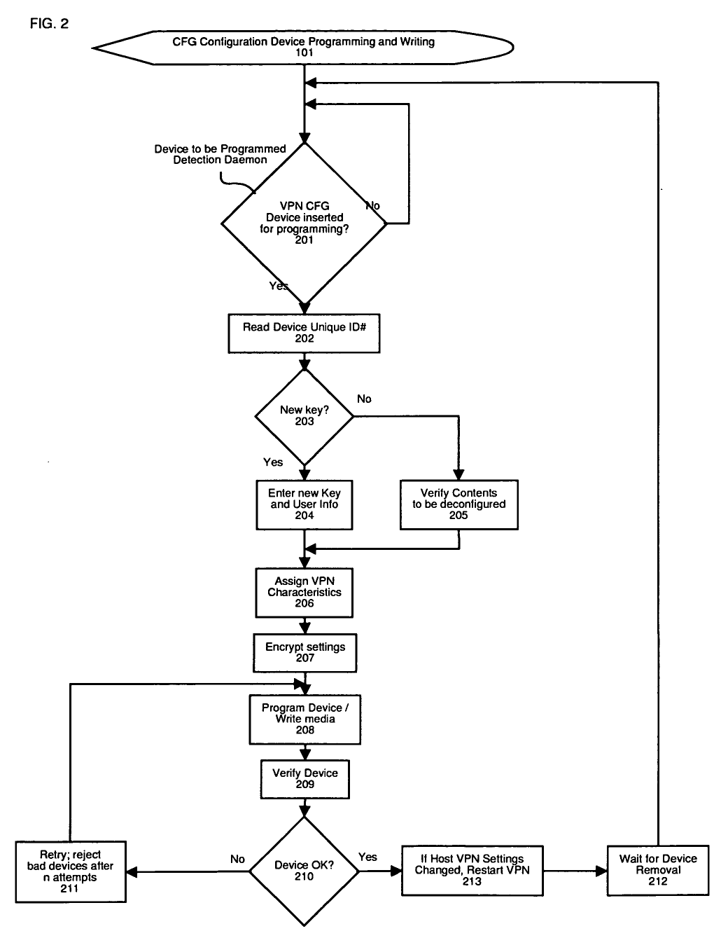

FIG. 2 illustrates a method for programming a VPN configuration device (CFG) 190, 191, 192, 193, 194, 195, 196, or the equivalent functions using various forms of write-able media 198 or programmable or reconfigurable logic devices 199, at the VPN control station 102, to prepare the device for use in a manner in accordance with the present invention.

While it is possible to use conventional devices such as writable media, the most advantageous use of the present invention occurs when the configuration apparatus is both portable, and contains a guaranteed-unique identification number; such devices are relatively common, in the form of SmartCard and JavaCard devices. The present invention can rely upon external security or identification devices. For example, in FIG. 1, CFG device 190 might take a very different form: the VPN configuration parameters may be stored on a conventional media device such as a floppy disk or a USB memory stick, probably in an encrypted form, and perhaps within the router/gateway, and with some or all of the encryption key derived from a separate and uniquely configured device such as an Radio Frequency Identification (RFID) tag. Under such a scenario, device 190 is then nothing more than the RFID tag, and the router/gateway incorporates remote sensing electronic circuits associated with such devices. When the tag is detected in the vicinity of the router/gateway equipment, an event is generated. The tag number is retrieved, and used as part or all of a decryption key, allowing the parameters to be retrieved from any convenient media device, or even from a remote site, over an insecure data network (but, via transmission of data packets that include encrypted data via a mechanism such as FTP). Since RFID tags can be made with a unique identification number, such devices could serve as a simple enable/disable device. For example, an RFID tag could be kept on a keychain; when the owner of the keychain enters a room, their presence could be detected, and VPN communications could be enabled while that keychain is in the vicinity of the router/gateway.

In FIG. 2, a daemon process 101 (and the equivalent daemon process 181 in the case of a Virtual Office Server) is shown for the purpose of detecting the insertion of a CFG device, although one skilled in the art will recognize that this function could be performed by an operator upon insertion or attachment of a device that is to be programmed, or by a variety of hardware detection schemes such as switches or optical detectors; upon detection of such an event, the daemon process begins. It should be noted that such a daemon is similar in form, but different in function, from daemon processes 115, 153, 163, 173, 183 in FIG. 1, such as those used at VPN router/gateway devices 112, 151, 161, 171, or 180 in FIG. 1. In the case of daemons 101 and 181, the purpose is to detect a device that is to be programmed, while in the case of daemons 115, 153, 163, 173, or 183, the purpose is to detect the insertion or removal of a CFG device for the purpose of configuring, reconfiguring, enabling, or disabling the VPN functions for the associated router/gateway equipment.

Upon detection or annunciation of a CFG device to the VPN control station, the configuration setup procedures begin. Each CFG device includes an identification (ID) number, which is guaranteed to be unique, typically by use of a 64-bit or 128-bit key value. At box 202, the unique CFG device ID is read, and the key value is compared to VPN configuration database 104 entries from FIG. 1. If the device is already known, in other words, this is not a new key, then the existing owner identification settings in the CFG device will be erased in preparation for programming as shown at step 205, although it is possible to override these values if desired. If the CFG device ID represents a new device to this system, the operator is prompted to enter various user information; that information, plus the CFG key value, are added to the VPN configuration database 104.

Next, the operator is prompted to enter various characteristics which will apply to the associated user and VPN router/gateway device(s), although one skilled in the art will recognize that entry of such information could be automated by the use of additional configuration or other databases 105 as shown in FIG. 1. These characteristics may have little or nothing to do with direct configuration of the VPN; rather, they might include information on the type of user, an associated department, or other employee information. Direct VPN characteristics, such as address/netmask pairs necessary to enable basic VPN functions between the client router/gateway device 151, 161, or 171 in FIG. 1, and the corporate LAN VPN router/gateway 112 or Virtual Office Server router/gateway 180 in FIG. 1, can be determined by the program or by direct manipulation by a skilled operator. The programmed information may include Points of Interest (POI) settings, concerning resources available to the employee. Additional data includes the address, netmask, and characteristics of various other network attached devices such as printer 131 or network device 132; in the event that VPN policy allows the use of client-to-client device sharing, the additional data may include the address, netmask, and characteristics of client-owned devices such as printer 157 or network-attached device 158, such as a modem, fax machine, or many other types of addressable devices. Once all of the settings have been selected for the CFG device to be programmed, the data is encrypted using one of the standard methods, such as a public key cryptographic system. A digital signature is also computed using the unique ID code within the CFG device, allowing verification of the device and settings when it is eventually inserted into or attached to the appropriate router/gateway device.

At box 207, the encrypted data is written to the device or media using any of a variety of methods such as a custom programming interface, serial interface, or various other methods such as JEDEC interfaces which are not described further here. The written settings are read back at box 209, to verify that the device was programmed correctly in the test at box 210. If the device contents do not match the expected value, a retry loop is entered at box 211, and if after a certain number of attempts the device still can not be programmed and verified, it is rejected, the associated key entry is removed from the database or flagged in the database as permanently unavailable, and the operator is prompted to insert a new device. If, at box 210, the device verified correctly, the operator is prompted to remove the device and the control program waits for the device to be removed, possibly by detecting the removal via a daemon process similar to daemon 201 or part of daemon 201. Either before or after device removal, if it is determined that programming the client VPN device will also result in a VPN configuration change to the host VPN router/gateway device 112 or 180, the new configuration parameters for those host network router/gateways will be sent to those devices or the operator will be prompted to retrieve their CFG device if one is used and the CFG device is then reprogrammed in a manner similar to the client CFG devices. Upon reprogramming, or after sending local configuration updates to the router/gateway using well-known techniques such as SNMP, the host router/gateway device is restarted, and VPN operations resume.

One embodiment of the present invention modifies the host and/or client update processes, such that reconfiguration is deferred to some future time, or upon the occurrence of some specific event. For example, it can be determined that a large-scale VPN reconfiguration will be needed because of the addition of some employees; rather than effecting the change immediately, the reconfiguration can be deferred to a specific time, such as the following Monday at 5:00 AM. It is also possible to mark a set of VPN configuration parameters which will replace the current primary parameters, if, for example, the primary VPN becomes unreachable. The system operator can then force all clients to reconfigure by simply reconfiguring the central LAN parameters at some future time. This approach can also be effective as a fall-back in the event of a security or system breach; the CFG devices would then include alternative fall-back settings, and if a security breach is ever detected on the main LAN, the system operator can confidently reconfigure that LAN without concern about whether all of the clients will be able to continue their access.

It is possible, and in many cases useful, to maintain a separate set of secondary or default VPN parameters which can be consulted in the event that the primary VPN settings cannot be used. Typical uses of such a system include fail-safe operation to an alternative VPN connection point, for example, in the event of equipment failure. It is also possible to cause these parameters to be used after expiration of a primary VPN connection, allowing, for example, “limp-mode” access during the closing days of a project, or after an employee leaves the company. When combined with timed or event-driven reconfiguration of the VPN, the combination of a primary VPN connection and a fail-over connection can provide a variety of unique VPN services.

At box 202, the CFG device ID number is read from the inserted device; in the event that simpler, non-keyed but writable media such as barcodes are being used, the ID number is the unique ID number that is built into a router/gateway device similar to 112, 151, 161, 171, or 180 in FIG. 1, but which has a permanently installed and non-removable unique CFG identification device, which number is provided to the VPN control station operator either by inspection of the associated router/gateway device, by remote control of such a device, or even by the user of such a device.

The methods and apparatus of the present invention can also be used in situations where a device with a guaranteed-unique identification number is not available. In this situation, it is incumbent upon the system operator to define identification numbers that are at least unique within the context of the current VPN, although the ultimate security of such a technique, and it's ability to automatically detect configuration errors, may be compromised rather easily. Such mechanisms are best considered as fall-back or lower-cost alternative implementations of the present invention.

### Description of Secure Transfer of Configuration Information

Regardless of the configuration delivery method, the associated VPN data is ready for use by client router/gateway devices 151, 161, 171. The employee or other agent transports the devices to the associated device and inserts it or attaches it to start the VPN configuration process.

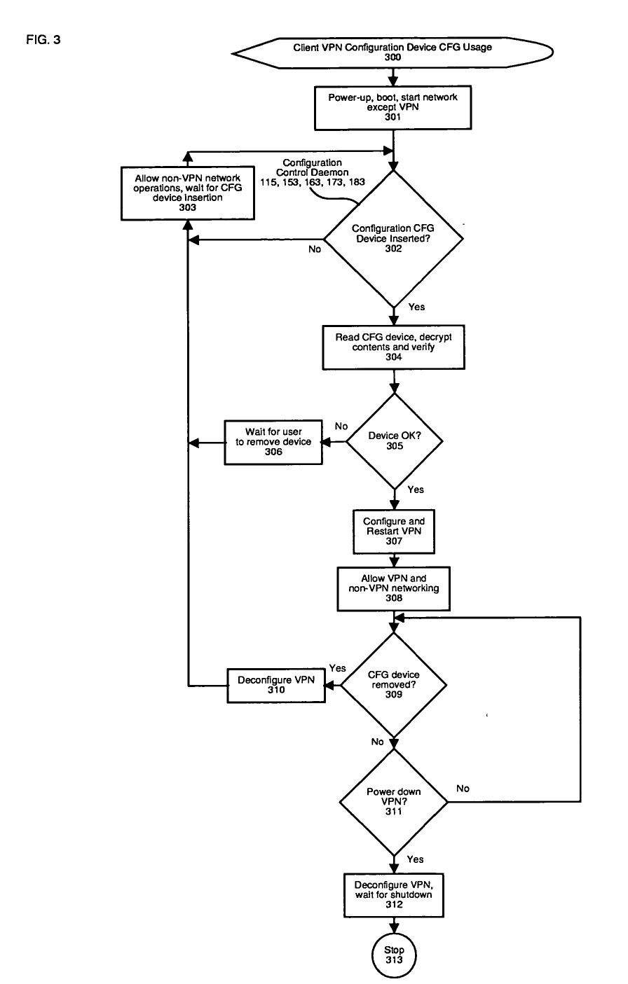

FIG. 3 illustrates the use of a configuration device CFG 190, 191, 192, 193, 194, 195, 196, or equivalent media devices 198, 199 from FIG. 1, to configure a client VPN router/gateway 151, 161, 171, or a configuration device-equipped host network router/gateway 112, 180 in FIG. 1. At box 301, the router/gateway device undergoes a conventional startup or boot procedure. At decision point 302, the router/gateway determines, perhaps via the use of a configuration control daemon associated with step 302, whether or not a configuration device is available, such as by direct attachment or via some other enabling device such as a separate secure key or radio frequency ID device. If a configuration device is not available at startup, the router/gateway device can still provide general networking communications via box 303 between the local network 103, 150, 170 and the public data network 100 from FIG. 1, or directly between a potential VPN client 164 and the public data network 100, although VPN functions are not enabled for communication with the corporate LAN 103, with other VPN LANs 150, 170, with direct VPN clients 154, or with a Virtual Office Server 189 until and unless the configuration device is available.

If a CFG device is inserted, the device contents are read, decrypted, and verified at box 304 by any of a number of methods which do not affect the present invention. If the contents are determined to be invalid at decision point 305, the user is instructed to remove the device, although it does not matter if the device is removed since VPN operations will not commence, and non-VPN communications may continue as in box 303. If the CFG device contents are valid, the VPN is configured or reconfigured at box 307, and the VPN functions are started or restarted as appropriate. At box 308, both VPN and non-VPN networking functions are valid, and the router/gateway equipment enters a state 309, where it waits for the device to be removed or detached or otherwise disabled, perhaps due to some other mechanism such as physical separation of a radio frequency ID tag, thus signaling a desire to end VPN communications. If the device is removed or disabled, the VPN is deconfigured at box 310, and only non-VPN communications may occur as shown in box 303. If the device remains in place, a power-down check is made, and if a power-down sequence is indicated, the equipment will deconfigure the VPN and perform a normal shutdown. If, on the other hand, a power-down request is not pending, the daemon or equivalent process will continue to check the condition of the CFG device at box 309.

In a variation on the previous description, another embodiment of the present invention, a failure to correctly verify the VPN parameters may result in an attempt to verify and use a secondary or other set of alternative VPN parameters. In yet another embodiment, failure to verify any set of VPN parameters results in notification to a central site, perhaps via an alternative and obscured VPN or other secure connection, indicating an attempt to compromise the VPN. In yet another embodiment, the secondary or other alternative VPN settings may share a digital signature with the primary VPN settings, thus reducing the chance that someone could compromise the VPN by copying only portions of the configuration dataset.

### Description of Typical Data Objects

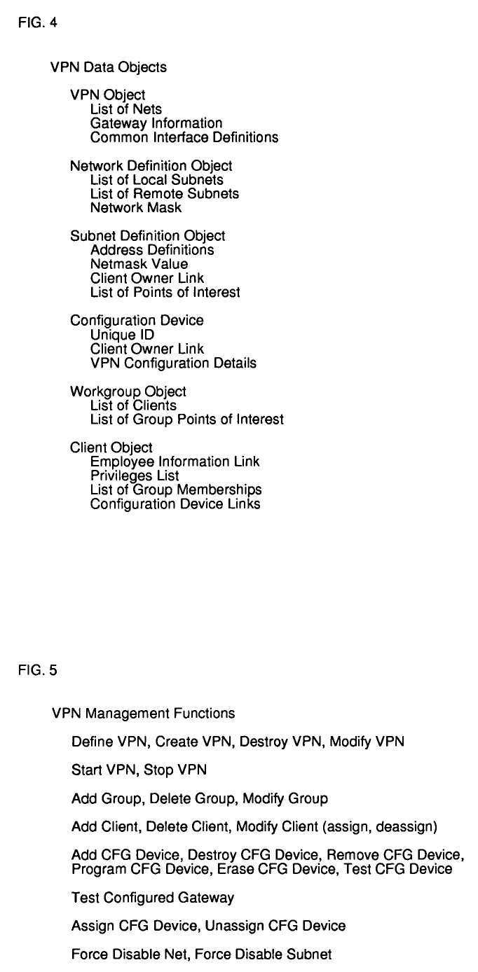

FIG. 4 illustrates data objects that might be used in a typical automatic VPN configuration, since the settings associated with such objects are involved in the definition of a VPN tunnel. Settings include items such as network, subnetwork, address mask, security keys, far-end security information, and other data to be described. The objects described are only one possible configuration of such data, and those skilled in the art will doubtless recognize that there are other possible forms that such data may take. The settings that are required for a specific VPN tunnel may be augmented with additional information such as network points of interest, ownership information, group and group membership data, lists of various access rights and privileges, and other data which is useful in any network environment including a VPN environment, but which data is not strictly necessary for the configuration of the VPN communications tunnel.

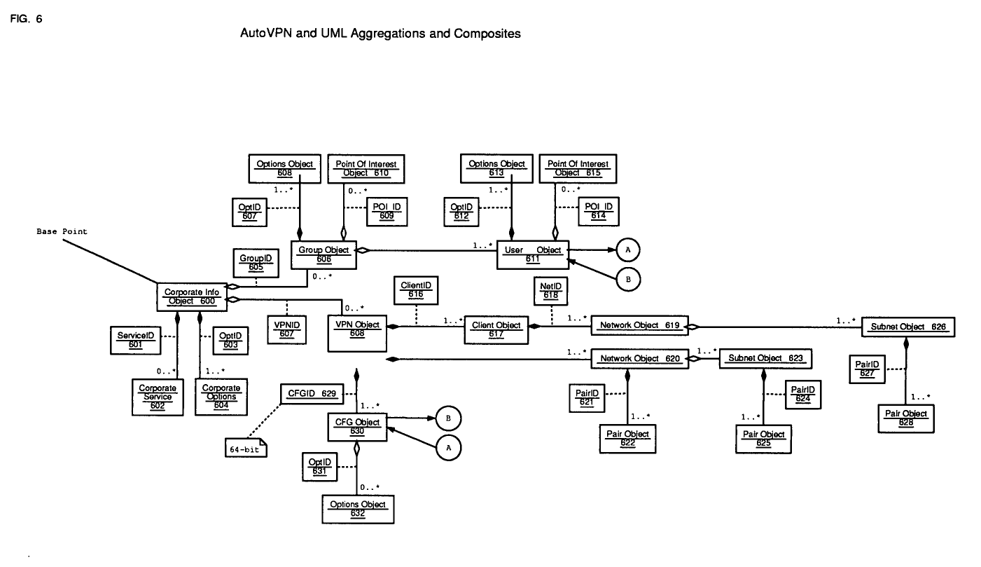

FIG. 5 shows a list of functions that might be used in an embodiment of the present invention. The next section of this document describes those functions, after the introduction of data types.

### Description of a Possible Database Layout for VPN Configuration

For purposes of the discussion, FIG. 6 discussion will begin from the point marked “Base Point”. FIG. 6 shows a typical database layout for a VPN configuration system.

FIG. 6 shows the aforementioned data types, arranged in a typical database topology for VPN configuration purposes. The drawing is not necessarily a strict implementation of UML, but should serve a person with reasonable skill to construct structures suitable to demonstrate the operation of the present invention. FIG. 4 data objects, combined with FIG. 5 functions, and FIG. 6 database, demonstrates interconnected set of data, programs, algorithms, and hardware that implements one embodiment of the present invention. In those figures there are a number of “ID” items that are used as an index into various tables of a database. Although not required for proper operation, such indices may simplify the layout, usage, and control of the database, and are thus included here as a potential options associated with the various data objects.

To simplify the diagrams, an object known as a “Pair Object” is listed. In the context of this invention, a Pair is the combination of an address, and the netmask associated with that address. These items are commonly used networking terms, but the gathering into a pair may not be familiar to the reader; nonetheless such a gathering does not change the network structure or setup, but may make it easier to find unused or potentially usable addresses in an efficient manner. An additional function of a Pair object may be to separate, by means of an appropriate flag value, the type of address and the netmask contained within the Pair; examples are a flag to indicate Internet Protocol (IP) version 4, versus IP version 6, which uses longer addresses and a different form of definition. Such changes in formatting and size can be easily hidden from other configuration records by use of a Pair object. For purposes of discussion, each Pair object has a unique Pair ID which is trivially assigned by a database manager or other similar mechanism.

Other objects in FIG. 4, FIG. 5, and FIG. 6 will now be described. Hierarchical relationships between the various objects is implied in the following discussion, but such a hierarchical structure is not required for the operation of a VPN or related database, and is merely a mechanism to improve various aspects of automatic configuration operations.

The VPN Object is a data structure that holds information specifically related to an overall VPN connection point, also called an endpoint. Typically, such a connection endpoint would be considered to begin at the Corporate office, and would describe aspects of the Corporate LAN as needed by VPN Clients and configuration devices. Each client is assigned a subnetwork value which is defined in such a way that it will not conflict with the subnetwork values for any other client. Other possible fields in a typical situation might include security keys, a List of Networks (Nets) or subnetworks associated with the VPN, information about the Gateway device itself, and interface definitions that are common to all devices that communicate through the Gateway associated with this VPN object. These fields might also include a VPN ID, which has a special consideration described later. Other fields are an ID number used to access Corporate Info, for example, the same value as the CorporateID described in a later data object. A VPN Object might also include a list of networks associated with the VPN, or a list of Groups associated with the VPN, when such groups are themselves associated to a particular network, although other configurations are possible. A further field of a VPN object would consist of an ID to point to a record of relatively static VPN-configuration data, such as the type of encryption to use or other settings; such settings must be known to the VPN configuration program, and are typically common between clients and the corporate LAN gateway, among clients engaged in client-to-client peer access when such access is allowed by the VPN security manager, and other similar shared settings. A VPN object, for purposes of this discussion, is also assumed to have an associated Pair object, referred to by a specific ID number; that Pair holds address and netmask information appropriate for the type of network in use for the VPN.

As noted previously, the VPN ID may have special significance related to security settings, group definitions, or both. In one sample implementation of the AutoVPN invention, for example, small devices which have a guaranteed-unique 64-bit identifier number that assures user security, guarantees against improper settings or incorrectly assigned key values, and acts as an index into several database tables related to device configuration. Such an ID could be assigned manually or with an automatic program that assures that there are no overlapping values within one network, and this is certainly a possible implementation scenario. However, AutoVPN can also use a universally-unique ID number such as those in the aforementioned security devices, which adds additional benefit to the system, namely, that it then becomes difficult or impossible to accidentally confuse multiple keys, especially for workers or for vendors who might have occasion to access more than one VPN network using an AutoVPN configuration device. Without a universally unique ID number, such accidental misuse is much more difficult to block.

The Network Definition Object describes characteristics of a full network, which can in turn consist of one or more subnetworks. Each Network definition is assumed to include a NetID field, a list of local subnets, a list of remote client subnets, a Group ID or a VPN ID, depending on whether or not group definitions are used in the VPN environment, and a Pair object that holds the address and netmask settings.

The Subnetwork (Subnet) Definition Object describes characteristics of a particular subnetwork, typically the address settings used in a remote office or home that is using a VPN device to communicate with the corporate network. Such subnetworks must be unique, and must avoid overlapping address ranges and various other settings. The automatic configuration programs use the data from the subnetwork and other objects to assure that there are no such overlaps or other violations. A Subnet object may be considered the leaf-node of a VPN configuration, although this is not strictly necessary. A Subnet object, for purposes of this discussion, is assumed to include a SubnetID value, an Owner ID value, and a list of various “Points of Interest”, described next.

A Points of Interest object is an abstraction that is not necessary for VPN configuration, but which can be useful in a typical VPN environment. A Point of Interest is defined as a device or service that is accessible to network users; examples might include a shared printer, a fax modem, or other network-accessible devices. A Point of Interest object holds information about these objects, and can be passed to automatic configuration programs to simplify access to such devices by a client. A Point of Interest object is, for purposes of this discussion, assumed to include a POI_ID field, a string representing the name of the item, a Pair ID to point to address and netmask values, and may include ID values associated with particular restrictions or permissions.

The Configuration (CFG) Device Object describes the settings associated with a physical configuration device as described in this invention. A CFG device object may include fields such as a Configuration Device ID, which has the same considerations as the VPN ID described in a previous section. A CFG device object may also include an owner ID field to point to an owner object, and a VPN_ID field, to provide a reverse link to the configuration database root for this VPN; such a link simplifies gathering information on a particular key when it is not otherwise obvious who the key might belong to, although again it must be emphasized that such a field is a convenience and not a strict requirement of the present invention.

The Workgroup Object describes a group of workers who share particular characteristics such as the name of the group (i.e., “Accounting” or “Engineering”), or who share access to a group of special devices, points of interest, or other items. A Workgroup object, for purposes of this discussion, may be considered to include a GroupID value, a VPN_ID value or a list of VPN_ID values in the event that a group spreads across multiple VPN clients, a GroupName field, and list of members (either by name, Client ID, or other method).

The Client Object describes a specific VPN client, typically a remote worker, but possibly an office location where more than one worker may need to connect to the corporate LAN via a VPN. A client object may be considered to include a ClientID value, which is perhaps related to an Employee ID or Office ID value. A client object may also include fields to list the configuration devices which are considered to be owned by this client, a list of privileges or allowed service, a list of allowed Points of Interest that may apply to this client, a list of group memberships, and other similar values which may be useful during operation of the VPN.

It has been noted that a client device may share a network connection with other devices, including computers or other equipment that is not considered a part of the VPN per-se. One embodiment of the present invention includes a network filtering table that rejects any attempt by such non-qualified network users to access any other portion of the VPN. For example, a common network operation is called a “ping”, and involves sending a specially formatted short data packet to another machine which responds with a short message. In many VPNs, any machine on a subnetwork may ping any other machine in the VPN, whether the machine resides on the local network or on a remote subnetwork. Using the network filtering extension, the VPN gateway can intercept such messages, determine if they originated at a qualified VPN client machine, and then forward (or reject) the packet based on a simple test operation.

Additional objects that may be useful during the automatic configuration of a VPN include information about the corporation or business entity when such settings affect the network characteristics. Examples of such objects might include a Corporate_Info object, a Corporate_Service object that is the equivalent of a Points of Interest object but with some minor additional information to assist configuration, and OptionBits objects. These are described next.

A Corporate Info object may contain a CorporateID value, a string to hold the Company name (which may act as a default VPN tunnel name), and a list of Service “advertisements”, that is, a list of services available to all Corporate VPN clients.

A Corporate Service object is similar to a Points Of Interest object, but may also include fields for a Service ID, which might match so-called “well-known types” of data. Examples of such items might be a description of the network website, File Transfer Protocol (FTP) site, Telnet access options, service names such as “HTTP”, “FTP”, and other network services, service ports such as “80” (the port address commonly associated with web traffic), “21” (the port commonly associated with FTP transactions), and other similar settings. Another common item to include may be an indicator for the Type of Service; typical examples are UDP (User Datagram Protocol) and TCP (Transfer Control Protocol); many service ports will accept traffic only via one or the other of such service types, as noted in so-called “well-known types” service lists. Service objects simplify the configuration of various client interactions from their side of a VPN connection, but again, are not specifically required to setup or use a VPN, and are thus considered adjuncts to the specific required information.

An Options Bits object can be used to hold various options settings for a VPN. One such option might be to indicate whether or not a VPN connection should be maintained if the VPN configuration key is removed from the router/gateway device. Thus, such option bits, which may be contained within the key itself and typically in encrypted form when so contained, can be used to change characteristics or operation of VPN-connected devices such as a client router/gateway. Examples of such bits might include the aforementioned “ALLOW_KEY_REMOVAL” option bit, a “KEY_WILL_OPERATE” bit that could, by remote access, be modified to completely disable a key without erasing it; such an action by the VPN system operator might necessitate bringing the key to the VPN control station to be re-enabled, for example, if there is a suspicion of security breaches, or if payments are not made, etc. Another useful option might include a bit to define whether or not a client can reprogram the device at their router/gateway; such a bit might be named “KEY_IS_CLIENT_PROGRAMMABLE”. Many types of keys will require special custom hardware to program the device; such hardware would often be available only through a VPN Control Station. Other types of keys might use more generic interfaces, such as Universal Serial Bus (USB), or other connection schemes; such hardware mechanisms typically allow both writing and reading attached devices, of which a CFG key may be one example. By use of an option bit, the control program may be told whether or not the key can be altered by the user, perhaps to hold additional, non-VPN data. The configuration daemon, described in a later section, or the device driver on the client router/gateway device, would enforce the policy described by this bit. If the various VPN settings including this bit was further shrouded, such as in an encrypted field in the key itself, then even if the key is placed in another device such as a general purpose computer, it would be difficult or impossible to reprogram the device in such a way as to gain knowledge of the VPN settings, bypass security settings or access restrictions, etc. Other option bits will certainly be apparent to one skilled in the arts.

The specific requirements of setting up a VPN tunnel may change depending on the network characteristics, and do not impact the claims made herein. For example, VPNs that are built using programming toolkits such as “IPSec” (Internet Protocol Security) may be markedly different from those built using brute-force programming techniques, yet both systems could benefit from incorporation of techniques, methods, and apparatus as described herein.

### Description of Typical VPN Configuration Functions

FIG. 5 lists typical functions that associated with one embodiment of the present invention, for the purpose of VPN management. The following paragraphs describe those functions.

Several functions are associated with definition of the VPN itself; the DefineVPN function is used to gather data such as static IP address values, VPN name, and many other values associated with the VPN. Create VPN uses those settings to establish a set of related database entities. Destroy VPN destroys a set of related database entities (but does not destroy the settings from Create VPN), and Modify VPN modifies the settings entered during the Create VPN process; it may also be desirable to delete those settings if no additional VPN connections exist, and that would be a task of Modify VPN.

The next set of functions is associated with operation of the VPN itself; StartVPN starts the VPN operations for all clients, and StopVPN halts operations for all clients. As will be seen, it is also possible to enable or disable a single client.

The next set of functions is related to groups of users; such groups are not a required part of a VPN but may help in the organization of such groups when they have related VPN needs and requirements. The functions in this group include Add Group to create a new group of users, Delete Group to dispose of the settings associated with such a group, and Modify Group to modify those settings.

The next set of functions is associated with specific users; they include Add Client, Delete Client, and Modify Client (including the ability to assign or deassign a client to a particular group, or a particular device).

The next set of functions listed in FIG. 5 are related to Configuration (CFG) devices. These include: Add CFG device (to “introduce” a new device to the system), Destroy CFG device (which disables, erases, and removes the device from the database), Remove CFG device (which removes the device from the database but does not destroy it; as a result of the removal, the user associated with that CFG device cannot access the VPN until and unless the key is re-enabled or reprogrammed), Program CFG Device actually writes the specific VPN configuration information into the device, Erase CFG Device erases a device, which may be necessary in some environments, and Test CFG device, to test the status and contents of a CFG key device. Two other functions, Assign CFG device and Unassign CFG device, are not related to a specific CFG device other than to associate a specific device to a specific user and/or group of users.

Additional functions listed in FIG. 5 include: Test Configured Gateway (to test the contents of a CFG device in a realistic network setting), Force Disable Net (to disable a group of VPN clients, or a complete network in the VPN structure), and Force Disable Subnet, which can also be used to disable a group of clients (when they share a common subnet), or a specific user (when clients do not share a common subnet, and a subnet is thus “dedicated” to a single, particular, client).

### Alternative Implementations of the Present Invention

Besides the above functions, there are many possible operational modes for an automatically configured VPN. The operational mode may be affected by the type of encryption device used, if any. It is also possible that some of the actions associated with automatic VPN configuration could be handled by a separate configuration daemon.

Numerous AutoVPN operational embodiments have already been identified, and others are certainly possible. Generic embodiments described so far include:
Secure Key—using a device with a unique security ID
Insecure Key—using a standard memory-only key device
Embedded Key—using a key embedded into a router/gateway or similar product
Tag Enabled—using a secure tag or other device not directly related to the configuration carrier device
Pseudo-Network Card Key—built upon PCMCIA or other card that has a full VPN hardware subsystem, effectively an entire router/gateway device, including it's own processor, memory, and other attached devices as shown later in this document, along with an embedded security ID device. A pseudo network card has the distinguishing characteristic that it appears as a standard bus-attached device or other generic interface, and operates independently of the host computer system.

### Description of a Computing Device Serving as VPN Control Station

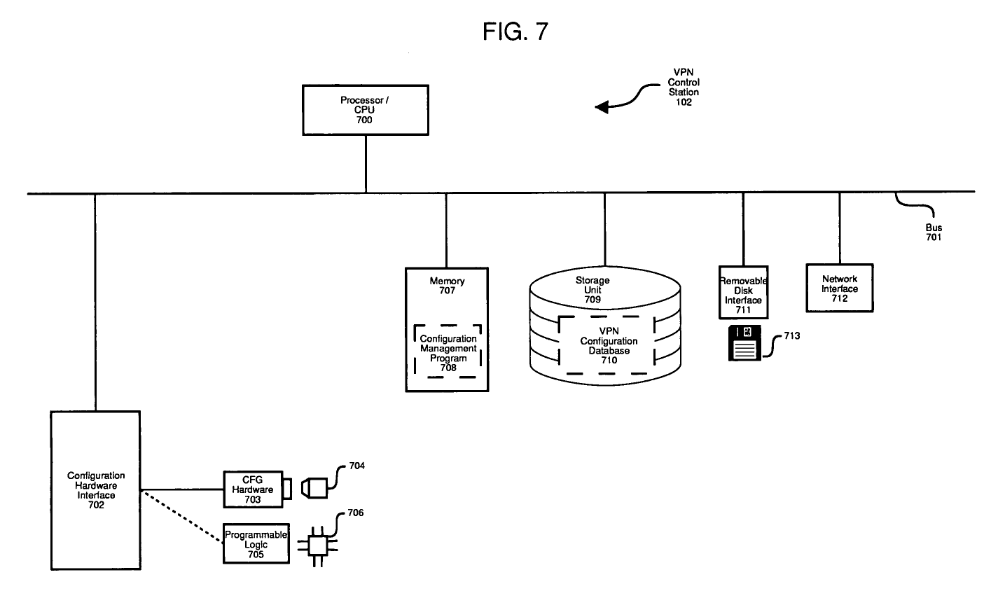

FIG. 7 shows a generic computing device which might act as a VPN control station in accordance with an embodiment of the present invention, however, VPN Control Station 102 may be any type of computing system or device.

In the embodiment illustrated in FIG. 7, VPN Control Station 102 includes processor 700 operating over a bus 701, through which processor 700 communicates with memory 707, storage unit 709, configuration interface unit 702, and potentially other devices such as removable disk interface 711, and network interface 712, Memory 707 includes VPN configuration management program code 708, which contains instructions and data to manage VPN router/gateways and to program the associated configuration delivery devices using configuration hardware 703, programmable logic hardware 705, or removable disk interface 711, to program the carrier devices 704, or programmed logic devices 706, or conventional storage media 713, when used in accordance with the present invention. Storage unit 709 includes VPN configuration database 710, which includes information regarding the structure of virtual private networks supported by the system, as well as specific information about each user and each configuration carrier device or associated security-enabling devices. The operations performed by configuration management program 710 are discussed in detail below.

While a network interface 712 is shown as part of the VPN control station 102, such a network interface is not strictly necessary, and in many secure situations, it may be considered desirable to have the VPN control station 102 remain separate from any network. Under those same conditions, the presence of a conventional removable disk interface 711 and associated media 713 may also be considered undesirable for security reasons.

### Description of Automatic VPN Configuration Management Code

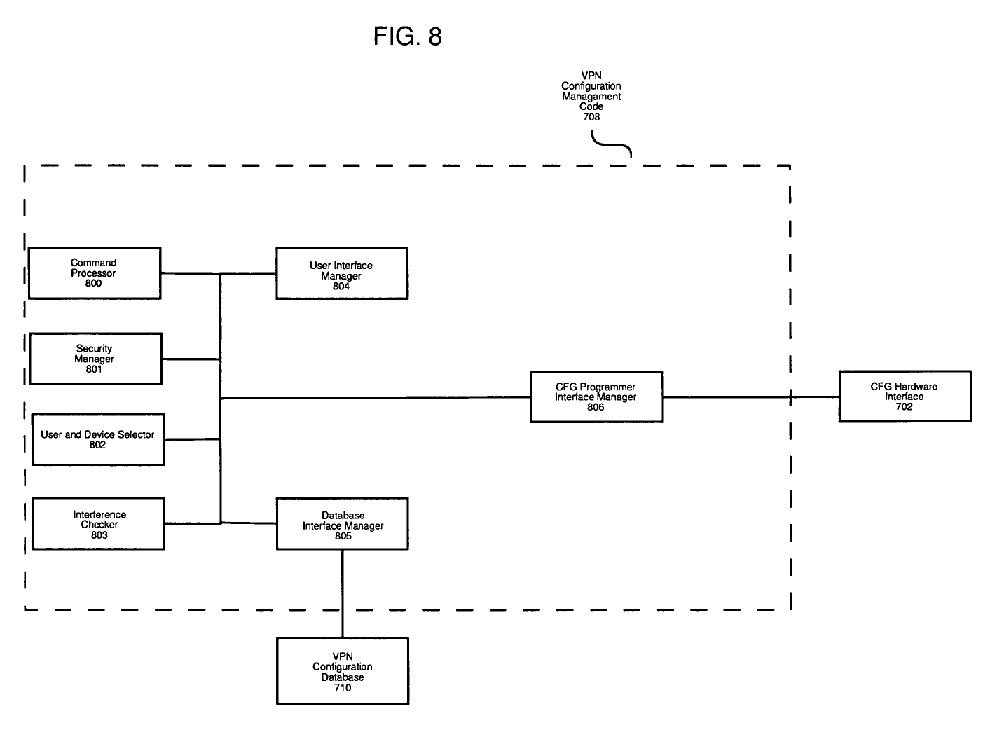

FIG. 8 is a diagram of part of the software architecture contained within VPN control station 102. The configuration manager may be partitioned into logical segments as shown in the diagram. Command Processor 800 communicates with the station operator via user interface manager 804, to receive input and to generate messages and operating instructions to the user. User input is verified by command processor 800, although some aspects of data verification is handled by the user and device selector 802. The VPN configuration database 710 is consulted via database interface manager 805, which is also responsible for assuring that the database is updated if changes are made. The interference checker 803 is used as part of the process to select an appropriate set of VPN configuration parameters for a particular end user. The security manager 801 encapsulates the resulting information according to the needs of a particular device, which can be found via database consultation or via a query operation to the CFG programmer interface manager 806, which is also responsible for applying the final configuration parameters to the configuration hardware interface 702. Configuration hardware interface 702 can take a variety of forms, depending on the specific type of configuration carrier device, as noted previously.

The VPN configuration manager code described in FIG. 8 operates as follows. Upon startup, or at the discretion of the system operator, the operator begins a configuration session. During the configuration session, the command processor 800 may cause the CFG programmer interface manager 806 to be checked for the presence of a new security device, or the operator may specifically request the command processor to proceed as if such a device has been presented to the system for programming. In the former case, the command processor requests the ID number of the device via CFG programmer interface manager 806, while in the latter case, the system operator is responsible for selecting a device from the list of available devices in the VPN configuration database 710, or by requesting that a new device be presented to the system, whereupon a number of related data items are requested as noted previously. The data received, whether from the CFG programmer interface manager 806 or from the system operator, is checked for interference, that is, that the device and associated user data is unique, by interference checker 803. Information about the associated user is selected by user and device selector 802, and presented to the system operator by user interface manager 804. It is possible to modify some of the associated data fields, and if such a step is undertaken, the results are again checked and verified for consistency and for potential interference; acceptable results are returned to VPN configuration database 710 via database interface manager 805. Once an acceptable set of data has been collected, command processor 800 calls security manager 801 to encrypt and otherwise manipulate the VPN settings. The encrypted results are then sent to CFG programmer interface manager 806, which presents them to CFG hardware interface 702 for writing to the configuration carrier device. Under those conditions where the user is known, the configuration device has a unique ID and that ID is valid, and where the device has been properly presented to the station, all of the previous steps, notably including the selection of VPN operating parameters, can be completely automated in such a way that no control station operator involvement of any kind is needed. In particular, the often confusing step of selecting network parameters for the remote client machine or network can be handled by the configuration management code 708. Furthermore, for those situations that provide Points of Interest (POI) settings for clients, those settings can be extracted from the VPN configuration database 710, and if the user of the current device wishes to make available various resources on their subnetwork, those resources can be entered via user interface manager 804, and saved to the configuration database. Except for the case where user data must be changed, or POI references added to the VPN configuration database 710, the only user involvement under this scenario is an indication, such as an audio beep, that the device has been successfully programmed.

While the previous discussion has focused on the situation where specific, known-unique configuration carrier devices are used, the present invention can also be used in the context of insecure media such as floppy disks or other configuration delivery media, with or without benefit of encryption. Under this scenario, the system operator is called upon to provide unique identifiers for each carrier device; however, the choice of identifier can still be automatically checked, the network parameters automatically selected and sent to an appropriate programming device (such as a removable disk drive), and the results can be verified to be unique. In other words, the automatic configuration of VPN settings can still be managed, in accordance with the present invention.

Embodiments of the present invention can be created that select from a range of appropriate VPN configuration settings, as noted in the previous sections. Eventually, however, it may be necessary to reconfigure the entire VPN, a situation which represents many sources of potential error for non-automatic configuration schemes. In the context of the present invention, command processor 800 can detect when the database of available network and subnetwork settings has been exhausted, for example. Under such a condition, the VPN can be completely reconfigured and the settings for each individual user can be automatically recreated, and the entire contents of the VPN configuration database 710 can be replaced with the new settings. However, it should be noted that once the VPN itself is reconfigured to use these new settings, many users may suddenly find that their VPN connections are invalid. As noted previously, the daemon processes on the client devices can be constructed in such a way that they detect situations of this type, and cause a default, but secure, VPN connection to be used. These secondary connections can be driven by the fact that the VPN seems to “disappear”, or based on some other event such as an external signal or the passing of a specified time.

When so used, the command processor 800 must also cause the default settings to be written to the configuration carrier devices. Furthermore, since the indicated VPN may not yet exist, characteristics of the VPN must be entered by the VPN control station operator via user interface manager 804. The set of starting conditions for the alternative VPN links are not significantly different from the set of starting conditions for a conventional VPN, and the command processor is capable of establishing all of the required settings at system initialization time; however, the station operator must indicate that the settings are to be used as fail-over settings, and not the primary VPN settings, and the mechanism for selecting the fail-over settings must be identified via a simple selection process.

### Description of a Computing Device Serving as VPN Client Station

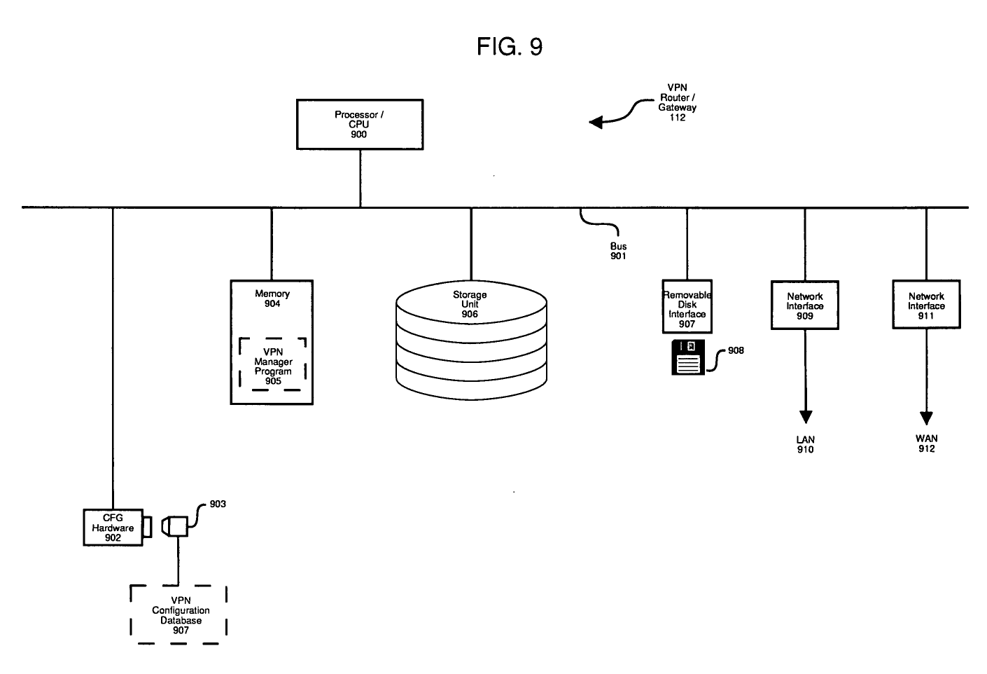

FIG. 9 shows a generic computing device which might serve as a client VPN network router/gateway such as devices 112, 151, 161, 171, or 180 in FIG. 1. However, VPN router/gateway 112 may be any type of computing system or device which provides network interface functions between networks (such as from the Internet 100 to LAN 103, 150, or 170 in FIG. 1), or directly between a network and a client device (such as remote client 164 in FIG. 1).

In the embodiment illustrated in FIG. 9, VPN router/gateway 112 includes processor 900 operating over a bus 901, through which processor 900 communicates with memory 904, storage unit 906, configuration hardware 702 (and thus with configuration carrier device 903), network interface 909 (which provides a connection to the local area network (LAN) 910), network interface 911 (which provides a connection to the Internet or other external wide area network (WAN) 912, and potentially other devices such as removable disk interface 907, Memory 904 includes VPN manager program code 905, which contains instructions and data to control the router/gateway device, and to setup, use, and shutdown VPN communication tunnels using configuration hardware 902, configuration carrier device 903, and the VPN configuration database 907 contained within the carrier device. Storage unit 906 includes various other operating code, program code, and data settings associated with typical networking operations. In most cases, it does not include a copy of the VPN configuration database 907, unless the system is allowed to operate without a carrier device, in which case, the parameters can be copied to local storage. VPN configuration database 907 is usually held on the carrier device 903, and includes information regarding the VPN setup values, Points of Interest (POI) items, or other aspects of the virtual private network supported by the system. The operations performed by VPN manager program 905 are discussed in detail below.

The VPN manager program 905 described in FIG. 9 operates as follows. Upon startup, the system initializes basic network operations between the LAN 910 and the WAN 912; examples of such operations include network address translation (NAT), packet forwarding, port forwarding, firewall functions, and other such operations. At this point, it is assumed that secure VPN communications are not yet started. At some point during the startup, a daemon process is started, as described in FIG. 3. Once the configuration carrier device is inserted, the VPN database is extracted from the carrier device (or other suitable location), is decrypted, and verified. If the contents are verified, the VPN configuration is performed using those settings, and the VPN process is started (conventional network functions can be setup, shutdown, and used even if the VPN is not currently available). The VPN, as well as conventional network operations, continue while the configuration carrier is attached to the router/gateway. In addition, if the carrier device includes Points of Interest (POI) settings for clients, those settings are extracted from the VPN configuration database 907, and may result in startup or shutdown of other services such as printer servers or other programs, using the configuration data. When the carrier device is removed from the system, the process is reversed, and the VPN tunnels are shutdown, and any POI programs are stopped or modified to remove access to the indicated resources.

One embodiment of the present invention uses a device known as a USB disk drive (although it actually uses solid state memory), to act as the configuration carrier device. In this embodiment, the data on the USB device is encrypted with a public key system, and the operating software on the router/gateway is pre-programmed with the keys necessary to extract the VPN configuration database 907.

One embodiment of the present invention uses a removable media floppy-disk interface 907, to read the VPN configuration database from floppy disk 908; the contents of the floppy are encrypted using a key derived from an RFID tag, and the CFG hardware 902 is replaced with an RFID detector. Presence of an RFID tag is treated in much the same way as the presentation of a carrier device as noted in the previous paragraph, except that the configuration database is read from the floppy disk using an identification scheme based on the RFID identification number.

### Description of a Programmable Key Device

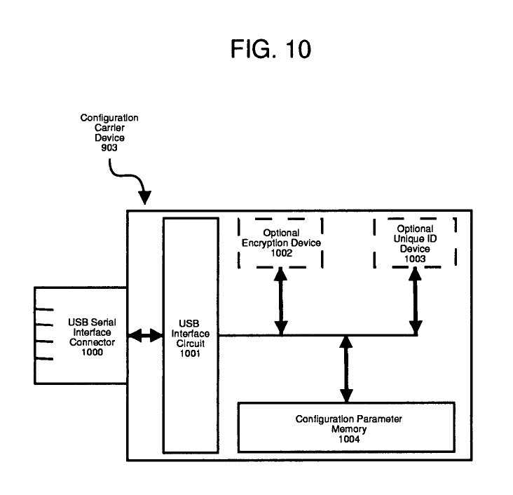

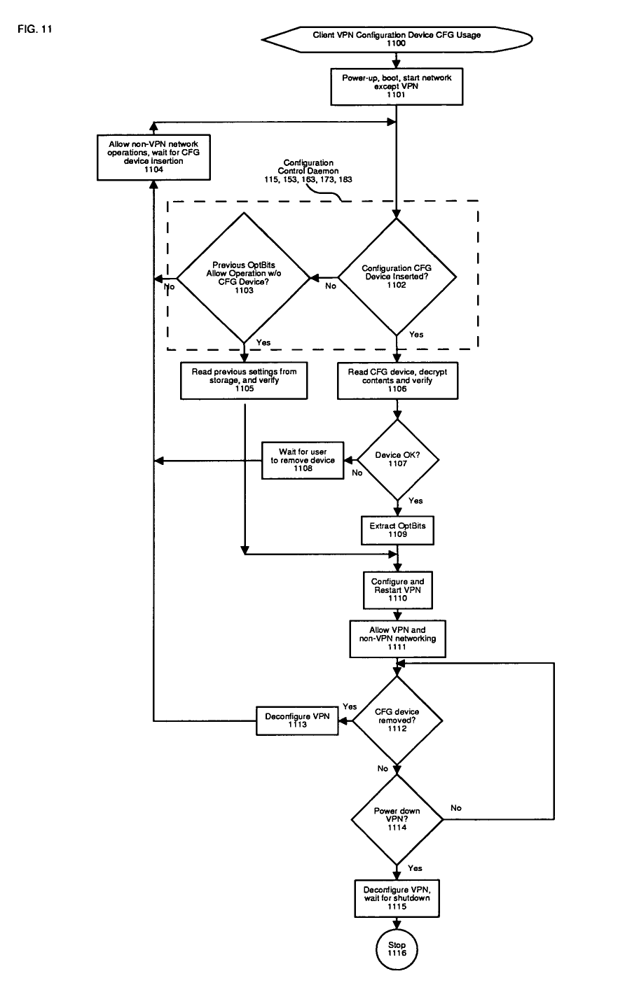

FIG. 10 shows an example of a programmable key device based upon a device called a “USB Disk Drive”. When so used, the resulting device is known as a Configuration Carrier Device. Upon insertion of such a device into a Control Station as defined in the present invention, various VPN and related parameters can be stored in the Configuration Parameter Memory 1004, via the USB Serial Interface Connector 1000 and USB Serial Interface Circuits 1001. Upon insertion of such a device a client computing system incorporating an embodiment of the present invention, the client system is then able to query the Configuration Parameter Memory 1004, via the USB Serial Interface Connector 1000 and USB Serial Interface Circuits 1001. Based on the results of those queries, the configuration parameters can be verified, and a VPN connection established with the host system or systems defined by the configuration parameters. It is also possible to create such a Configuration Device with a Unique ID Device number 1003, or an Encryption Device 1002. When so extended, the fully automatic aspects of the present invention, and the secure delivery of those parameters to client devices, can be more readily assured.

### Description of Carried Attributes that Control Key Operations

FIG. 11 demonstrates a method for changing the operational nature of a configuration device. In this specific example, a set of Option control structures is included in the configuration key, and the operational code of the device can access those structures to determine if particular operational modification are permissible, in this case, whether or not the VPN connection will be allowed to persist even if the security key is removed from the system. The operations in FIG. 11 extend the operations shown in FIG. 3 in several steps.

In FIG. 11, upon powerup and after conventional network operations have begun, box 1102 determines whether a configuration key is present. If a device is detected, it is read and verified as previously described. If a device is not detected, the Option controls (OptBits) settings, perhaps held in encrypted form on the local storage system, was defined in such a way that various operations such as VPN operations, are allowed without the CFG device present. If the decision fails, the system operates nearly identically to FIG. 3. If the decision succeeds, the former VPN settings are retrieved from local storage, and control resumes at the point where the VPN is configured and started in box 1110. For the case where the device is detected and the results have been verified, box 1109 indicates that OptBits are extracted, and those settings are saved for various purposes such as determining whether startup configuration device presence is necessary. Again, these settings will often be kept on local storage in encrypted form, as would a copy of the VPN configuration parameters. Note that, when used in this way, if the CFG device also includes a security key, then the local copy of the VPN parameters must be decrypted while the security device is attached, and then saved to local storage, either in unencrypted form, or encrypted in such a way that a security key is not needed. Finally, during normal operations, if the decision process at box 1112 determines that the CFG device has been removed, the VPN is shutdown, unless an OptBits setting is present that indicates VPN operations are allowed without the CFG device; if such operation is allowed, removal of the key will have no effect.

In a similar manner to the extraction and use of Option control structures, the control programs can also be modified to look for and use Points of Interest information that might be held in the configuration device. If such POI information is found, it can be extracted, and cause various other programs and processes to start. Conversely, at the decision box 1112, if it is determined that the CFG device has been removed, the POI-related programs and processes can be stopped, if necessary. Starting and stopping of POI-related programs can be tied to insertion or removal of the configuration device, or they may be controlled by OptBits settings, or both, depending on settings and decisions on overall VPN policy made by the system operator at the time that the configuration carrier device is programmed.

### Description of a Pseudo-Network Device Embodying Aspects of the Present Invention

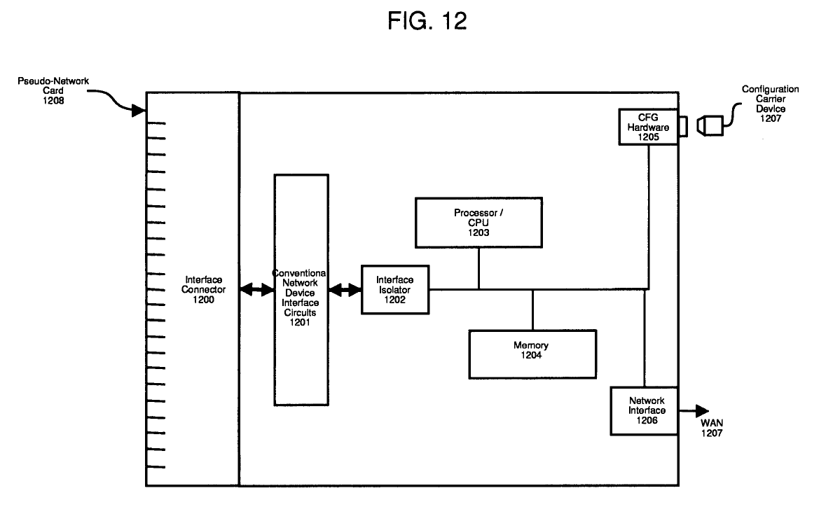

FIG. 12 shows a mechanism for a pseudo-network interface card which contains an embodiment of the present invention, but which appears to a computer or other computing device as a conventional network interface device such as a PCI- or ISA-bus Ethernet card, PCMCIA wireless interface card, or other such device. Using this mechanism, the complexities of the present invention can be hidden from client machines incorporating such a card, and only standard “device driver” interfaces are required when using the network interface, yet the resulting network connection, typically on the Wide Area Network (WAN) port, can automatically participate in an appropriately configured VPN. In FIG. 12, the client system interacts with Conventional Device Interface Circuits 1201, via an appropriate Interface Connector 1200; examples of such an Interface Connector might include USB, PCI, ISA, or other suitable mechanisms. Typical Conventional Device Interface Circuits 1201 consist of “registers”, which are various groups of bits held by various hardware mechanisms, and those bits define and control the operation of the network interface directly. In this embodiment of the present invention, those bits do not directly control the network interface. Instead, a local Processor or CPU 1203, interacts with the register settings via an Interface Isolator 1202. The local processor 1203 uses Memory 1204 to hold operating code, and various dynamic values, to implement the embodiment of the present invention. The local processor 1203 also controls the true network interface 1206. Furthermore, as described elsewhere in the present invention, the operations of the local processor may be affected by the insertion or removal of a Configuration Carrier Device 1207, via CFG Hardware 1205, resulting in automatic establishment or shutdown of the corresponding VPN “tunnel”. It is worth noting that the host computer does not have to be aware of the presence of such a processor and memory, or any other components of the pseudo-interface, and in fact, the Processor 1203 may even use a completely different operating system and related code. For example, a host machine running the Windows operating system, would have a device driver is aware of only the Conventional Network Device Interface Circuits 1201, while the local Processor 1203 might run Linux or some other realtime operating system, and be equally unaware of the presence of a host operating system working via Interface Connector 1200.

1. A method and apparatus for automatic configuration and management of a virtual private network operating over a public data network or insecure private network including a plurality of virtual private network gateways or devices (“clients”) so that communications within the virtual private network are channeled through the virtual private network gateways or directly to client devices, with secure delivery of configuration information to devices capable of using that information to automatically configure their own virtual private network and subnetwork characteristics, or using insecure delivery but enabled by the presence of a separate security device, the method comprising:
centralized configuration of the characteristics and operational parameters of a virtual private network, assigning subnetwork connection parameters on a host system and the corresponding network and subnetwork connection parameters on one or more client systems, and verifying that conflicts do not exist between defined subnetworks used by various client networks or subnetworks, and reconfiguring one or more client networks or subnetworks based on the result of certain verification checks;
reconfiguring the carrier devices or other security devices among participants in a secure VPN connection, thus changing the characteristics of one or more associated sessions, and potentially with time-restricted access to the VPN;
reconfiguring the carrier devices or other security devices among participants in a secure VPN connection, with a specified time for the configuration parameters to take effect, or upon the occurrence of a an agreed-upon specific event, such as inability to reach a particular VPN node (such as the corporate node), perhaps because that node has specifically been reconfigured by some other process;
inclusion of general network services or “points of interest” (if any) available to VPN clients, such as printers, network storage devices, software programs, or other network-accessible functions which may be of interest or benefit to VPN clients, including but not limited to device addresses, names, configuration settings, access-control information, and other data necessary for the VPN client device to automatically configure the VPN client system so that it may access and use such devices and services;

2. The method of claim 1, further comprising the steps of;
a method and apparatus for delivering virtual private network configuration and management information to one or more virtual private network gateways or devices, including client gateways and devices, corporate LAN gateway, or branch LAN gateways, providing for secure encrypted delivery of configuration and management information, or unsecured delivery of that same information in cases where security is not an issue, the method comprising:
automatically selecting an appropriate set of configuration parameters, potentially based upon characteristics of the person or group which will use the parameters, and transmitting the configuration parameters to an encrypted key device via one or more of several possible physical interface, transmission, and programning methods, or;
using reconfigurable logic devices, which are configured on the direct interpretation and translation of the encryption algorithm or the encrypted data provided by the centralized configuration management system, or;
using reprogrammable logic devices which are embedded into pseudo-network cards or similar devices such as modems, which devices can then be used by client devices without further consideration of the fact that a secure and automatically configured VPN connection results from the use of the security device, or;

3. The method of claim 1 and the apparatus of claim 2, further comprising the steps of:
use of the resulting programmed, encrypted or non-encrypted but keyed device with configuration information, which device is inserted into or attached to a client virtual private network gateway or direct access device, or which may be built into the device and enabled by the presence of an appropriate security device. Upon insertion, attachment, or detection, a daemon process on the VPN device to be configured detects the presence of the security device, retrieves the VPN and any other configuration information from the device or from other appropriate media, and uses that information to setup the VPN connection with the host system and other devices and points-of-interest, potentially including such connections between two or more VPN clients;

4. The method and apparatus of claims 1 and 2, further comprising the steps of:
use of a default, encrypted and secure data channel to transmit VPN configuration information to one or more client VPN gateways or direct access devices, which devices are either known to the host configuration system, or can be determined to be valid potential members of the VPN through encryption schemes such as public-key and digital signature methods. The transmitted data is delivered to a daemon process, which configures the security device, whereupon the VPN then operates over a separate encrypted tunnel using the provided characteristics. The associated VPN may be restricted in various ways, including time restraints. Furthermore, the non-default configuration information may be caused to activate at a specific time in the future, or;
a method to use a separate, but individually defined secure, encrypted, default network connection to present potential clients to a VPN host system, to return encrypted VPN configuration and management information via that default secure network connection, to automatically configure the VPN client device using that configuration and management information, and to open a separate connection, circuit, or virtual circuit between the client VPN gateway or device, the VPN host and various resources, devices, and other points of interest available to the VPN host and other VPN clients, resources, and devices, when such access is allowed. An aspect of this mode of operation is that the individually defined secure connection is controlled by the host configuration manager by virtue of the fact that every keyed device includes a unique ID code that is known to the manager before any such connection attempt is made, even if the key device is otherwise unprogrammed;
mechanisms for inclusion of multiple VPN configuration parameters sets within one or more configuration devices, and defining fail-over, fall-back, or event-driven changes to the VPN configuration using one of these secondary configuration parameter sets under specific circumstances.

5. The methods and apparatus of claims 1 through 4, further comprising the steps of:
a method and apparatus for automatically configuring a virtual private network client gateway or device using the delivered virtual private network configuration and management information, allowing various client configuration strategies and operating modes such as configure-once, dynamic-configuration, time-delayed reconfiguration, and forced-deconfiguration;
a method and apparatus for the host control and configuration system to automatically stop one or more virtual private network connections using one of several methodologies;
a method for forcing deconfiguration of one or more virtual private network clients access key devices, from a control computer located elsewhere in the virtual private network, overriding the client configuration information and disabling the client virtual private network configuration, connection, access control, or other functions until and unless the affected key device, client gateway, or client direct access device is reconfigured or reprogrammed;
a method for checking or challenging the validity of a connection from a control computer located elsewhere on the virtual private network;
a method for conveying new configuration parameters to a participating device in a virtual private network, said new configuration parameters to take effect at some future time or in response to a specific event;

6. The methods of claims 1 through 5, and the apparatus of claim 2, further comprising the steps of:
a method and apparatus for automatically starting or restarting one or more virtual private network connections using one of several connection methodologies, and based on the configuration information provided from the host configuration manager. An example of such use would be to start a VPN connection, without disturbing other potential ongoing network traffic through the client device, when a secure key device is attached to or inserted into the appropriate client gateway device or direct access device, or when the presence of an appropriate security device is detected;
a method and apparatus for automatically stopping one or more virtual private network connections using one of several connection methodologies, and based on the disconnection or detachment of the configuration device, or the disappearance of an appropriate security device. An example of such use would be to stop all VPN traffic, but still allow other network traffic to the public network, whenever the key device is removed from the client gateway or direct access device or when a device such as a specific radio-frequency ID tag is not detected nearby;
a method for maintaining and using the VPN configuration information even if the configuration key device is removed from the client gateway or direct access device, allowing the key device to be reused by other potential clients after it has been appropriately reprogrammed. A benefit of this mode of operation is that a key device can be reprogrammed over the course of days while the VPN is still allowed to function to the benefit of the client;

7. A method and apparatus using the previous methods and claims, defining a new topology of managed VPN network wherein there is no corporate LAN per-se, but rather, a single server which configures and manages all of the clients or branch LAN members of a VPN providing the concept of a Virtual Office, existing only within the Virtual Private Network, the connected client machines and subnetworks, and the Public Network (or insecure Private Network) cloud. When used in such a configuration, the VPN Control system becomes a Virtual Office Server, potentially providing company services such as web presence, email servers, related services, connections between distributed workers including individuals or groups of workers, and providing those workers with additional, private services of various types;

8. A method for configuration service provided by a trusted third-party, such as a certified service agency. Such services may be available anywhere, using established certification procedures. An example of such an operation might be a trusted security company with worldwide presence, who can challenge and verify potential VPN participants, certify their identity, and provide programming for the security device to be used in the VPN, thus simplifying access to new and remote employees, agents, representatives, or other personnel who may require access to a specific VPN.

9. A new type of pseudo-network interface card which card appears to a computer as a conventional network interface card of some bus type such as PCI, PCMCIA, or other common hardware-oriented connection, which device includes a completely separate VPN subsystem that is isolated from that bus interface, whether or not it employs the features and mechanisms of the prior claims and apparatus.
